(19) United States
(12) Patent Application Publication
(10) Pub. No.: US 2017/0255043 A1
(43) Pub. Date: Sep. 7, 2017

(54) STRUCTURAL COMPONENTS OF LIQUID CRYSTAL PANELS AND GATE COFS AND LIQUID CRYSTAL DEVICES

(71) Applicant: Shenzhen China Star Optoelectronics Technology Co. Ltd., Shenzhen, Guangdong (CN)

(72) Inventors: Yuchun HSIAO, Shenzhen, Guangdong (CN); Chengwen QUE, Shenzhen, Guangdong (CN); Gang YU, Shenzhen, Guangdong (CN); Dehua LI, Shenzhen, Guangdong (CN)

(73) Assignee: Shenzhen China Star Optoelectronics Technology Co., Ltd., Shenzhen, Guangdong (CN)

(21) Appl. No.: 14/914,012

(22) PCT Filed: Jan. 5, 2016
(86) PCT No.: PCT/CN2016/070152

§ 371 Date: Feb. 24, 2016

(30) Foreign Application Priority Data
Nov. 19, 2015 (CN) 201510800405.8

(51) Int. Cl. G02F 1/1345; F21V 8/00; G02F 1/1333

(52) U.S. Cl. CPC G02F 1/1345; G02F 1/133308; G02B 6/0055; G02B 6/0088; G02F 2001/13332

(57) ABSTRACT

A structural component of liquid crystal panels and gate COFs, and a LCD are disclosed. One end of the gate COF structure connects to an edge of the liquid crystal panel, and the gate COF structure is bent from the edge of the liquid crystal panel toward a back side of the liquid crystal panel. The other end of the gate COF structure connects to the back side of the liquid crystal panel, and the backlight module is arranged behind the gate COF structure. The front frame is arranged around an outer side of the bending portion of the gate COF structure, and the liquid crystal panel, the backlight module, and the front frame cooperatively define a receiving space for the gate COF structures. The enhanced gate COF structures of the liquid crystal panel are compact such that the thin and narrow border design may be realized.

### BACKGROUND OF THE INVENTION

1. Field of the Invention

The present disclosure relates to liquid crystal display technology, and more particularly to a structural component of liquid crystal panels and gate COFs and liquid crystal devices (LCDs).

2. Discussion of the Related Art

With the development of liquid crystal display technology, lighter LCDs having narrow border have been the main trend. Due to the limitations of the outlook and the thickness of the LCD, the components and the fixing structures have to be configured so as to satisfy such requirement.

FIG. 1 is a schematic view of the conventional liquid crystal panel, wherein gate chip on film (COF) structures 2 are provided at two lateral sides of the liquid crystal panel 1 to process the scanning signals. The COF relates to the chip soft film encapsulation technology for fixing the driving IC on the flexible circuit board. As the gate COF structures are fragile and thus have to be protected.

FIG. 2 is a partial view of the conventional LCD. A top end of the gate COF structure 2 connects to the liquid crystal panel 1, and is bent downward from the liquid crystal panel 1. The gate COF structure 2 is arranged within a gap between a plastic frame 34 of the backlight module 3 and a front frame 5. With such configuration, the thickness of the backlight module has to be larger than the length of the gate COF structure. That is, the thickness of the backlight module is limited by the gate COF structure, such that it is difficult to satisfy the light and thin requirement.

FIG. 3 is also a partial view of the conventional LCD, wherein another configuration receiving the gate COF structure is shown. As shown, a left end of the gate COF structure 2 connects with the liquid crystal panel 1. The gate COF structure 2 extends from the left end toward a right end along a horizontal direction so as to be laid out in the gap between the plastic frame 34 of the backlight module 3 and the liquid crystal panel 1. With such configuration, although the thickness of the backlight module is not limited by the gate COF structure, but the border of the LCD is limited by the length of the gate COF structure, and it is also difficult to satisfy the light and thin requirement.

In view of the above, the light and thin requirement of LCDs is limited by the receiving configuration of the gate COF structure. It is necessary to enhance the structure of the LCD, such as decrease the occupied space of the components, such that the above requirement may be realized.

### SUMMARY

In order to overcome the above problems, a structural component of liquid crystal panels and COFs is provided. In addition, a LCD is provided. By enhancing the internal structure of the LCD and by decreasing the space occupied by the components, the thin and narrow border design may be accomplished.

In one aspect, a structural component of liquid crystal panels and gate COFs includes: a liquid crystal panel and gate COF structures arranged at two lateral sides of the liquid crystal panel, wherein: one end of the gate COF structure connects to an edge of the liquid crystal panel, and the gate COF structure is bent from the edge of the liquid crystal panel toward a back side of the liquid crystal panel, and the other end of the gate COF structure connects to the back side of the liquid crystal panel.

Wherein the gate COF structure is bent by an angle larger than 90 degrees.

Wherein a chip is fixed on the gate COF structure, and the chip is received in an internal space defined by a bending portion of the gate COF structure.

Wherein the chip is arranged at a lateral side of the liquid crystal panel, or the chip is arranged to be opposite to the back side of the liquid crystal panel.

Wherein the gate COF structure is adhered to the back side of the liquid crystal panel by a double-sided adhesive tape.

Wherein a bending portion of the gate COF structure includes a hollow structure.

In another aspect, a liquid crystal device (LCD) includes: a liquid crystal panel, gate COF structures arranged at two lateral sides of the liquid crystal panel, a backlight module arranged behind the liquid crystal panel, a front frame arrange at an outer side of the liquid crystal panel and the backlight module, wherein: one end of the gate COF structure connects to an edge of the liquid crystal panel, and the gate COF structure is bent from the edge of the liquid crystal panel toward a back side of the liquid crystal panel, and the other end of the gate COF structure connects to the back side of the liquid crystal panel, the backlight module is arranged behind the gate COF structure, the front frame is arranged around an outer side of the bending portion of the gate COF structure, and the liquid crystal panel, the backlight module, and the front frame cooperatively define a receiving space for the gate COF structures.

Wherein the backlight module includes a film, a light guiding plate, and a reflective sheet arranged behind the liquid crystal panel in sequence, a plastic frame is arranged in a rim of the film, the light guiding plate, and the reflective sheet for fixing the film, the light guiding plate, and the reflective sheet, and the plastic frame, the liquid crystal panel, and the front frame cooperatively define the receiving space.

Wherein the LCD further includes a backplate arranged behind the backlight module and arranged at an inner side of the front frame.

Wherein a bending portion of the gate COF structure includes a hollow structure.

First, the gate COF structure is enhanced. Compared to the conventional technology, wherein the gate COF structure is received vertically or horizontally, the gate COF structure is configured to be bent to provide a compact structure. As the occupied space may be reduced, the limitation with respect to the thickness of the LCD and the length of the border caused by the gate COF structure may be reduced. In this way, the thin and narrow border design may be realized. In addition, the stress in the bending portion of the gate COF structure may affect the circuits on the COF. Thus, the hollow structure is proposed to release the stress. When designing the circuits of the gate COF structure 2, the locations of the through holes have to be configured such that the gate COF structure is prevented from being affected.

### BRIEF DESCRIPTION OF THE DRAWINGS

FIG. 1 is a schematic view of the conventional liquid crystal panel.

FIG. 2 is a partial view of the conventional LCD, wherein the gate COF structure is received vertically.

FIG. 3 is also a partial view of the conventional LCD, wherein the gate COF structure is received horizontally.

FIG. 4 is an exploded view of the LCD in accordance with a second embodiment.

FIG. 5 is an enlarged view of the portion “A” of FIG. 4.

FIG. 6 is a cross-sectional view of the LCD in accordance with the second embodiment.

FIG. 7 is an exploded view of the LCD of FIG. 6.

FIG. 8 shows one deformed structure of the gate COF structure in accordance with the second embodiment.

FIG. 9 shows one deformed structure of the gate COF structure in accordance with the second embodiment.

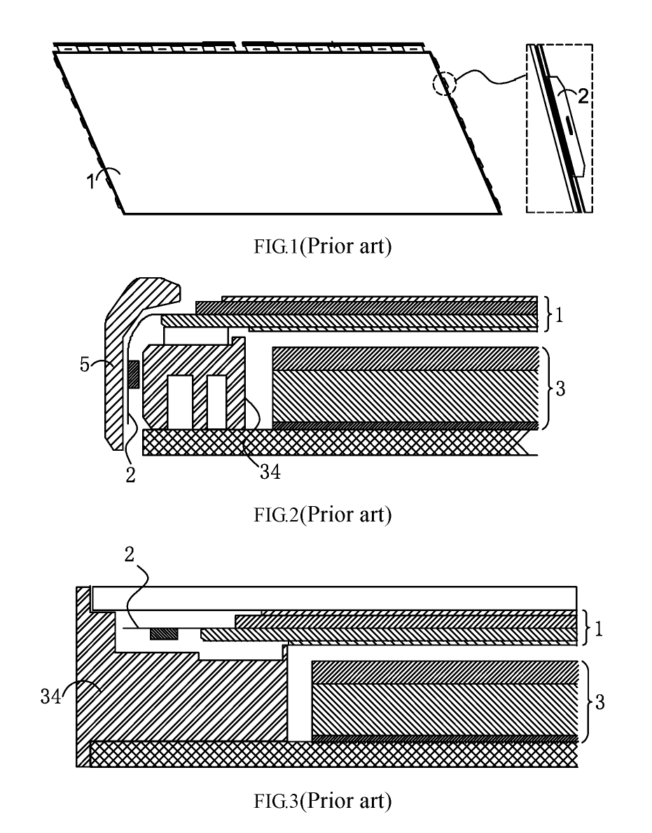

### DETAILED DESCRIPTION OF THE EMBODIMENTS

Embodiments of the invention will now be described more fully hereinafter with reference to the accompanying drawings, in which embodiments of the invention are shown.

Various example embodiments will now be described more fully with reference to the accompanying drawings in which some example embodiments are shown. In the drawings, the thicknesses of layers and regions may be exaggerated for clarity. In the following description, in order to avoid the known structure and/or function unnecessary detailed description of the concept of the invention result in confusion, well-known structures may be omitted and/or functions described in unnecessary detail.

In the present disclosure, it should be understood that the terms, such as in front of, behind, inner, outer, up, down, left, right, vertical, horizontal, transverse, and longitudinal, are only the descriptions illustrated in view of the drawings so as to simplify the description. The structure and the operations of the devices, components, and parts are not limited to the directional terms as stated above.

In addition, the terms not only illustrate the location or the relationships, but may include other meaning. For instance, the term “on” may indicate that one component is attached to another component or the connecting relationship therebetween. Those of ordinary skills may understand that the specific terms of the above-mentioned meanings depending on the circumstances.

In the present disclosure, a front surface of the liquid crystal panel, i.e., an image display surface, is referred to as the front side, and the rear surface of the liquid crystal panel, i.e., the back side of the LCD, is referred to as the back side.

In the first embodiment, a LCD includes a liquid crystal panel, the gate COF structures provided at the lateral sides of the liquid crystal panel, a backlight module arranged in a back side of the liquid crystal panel, and a front frame arranged at an outer side of the backlight module. One end of the gate COF structure connects to a lateral end of the liquid crystal panel, and is bent toward the back side of the liquid crystal panel. As such, the other end of the gate COF structure connects with the back side of the liquid crystal panel. The backlight module is arranged behind the gate COF structure. The front frame is arranged around the outer side of the bending portion of the gate COF structure. The liquid crystal panel, the backlight module, and the front frame cooperatively define the receiving space for the gate COF structure.

### Second Embodiment

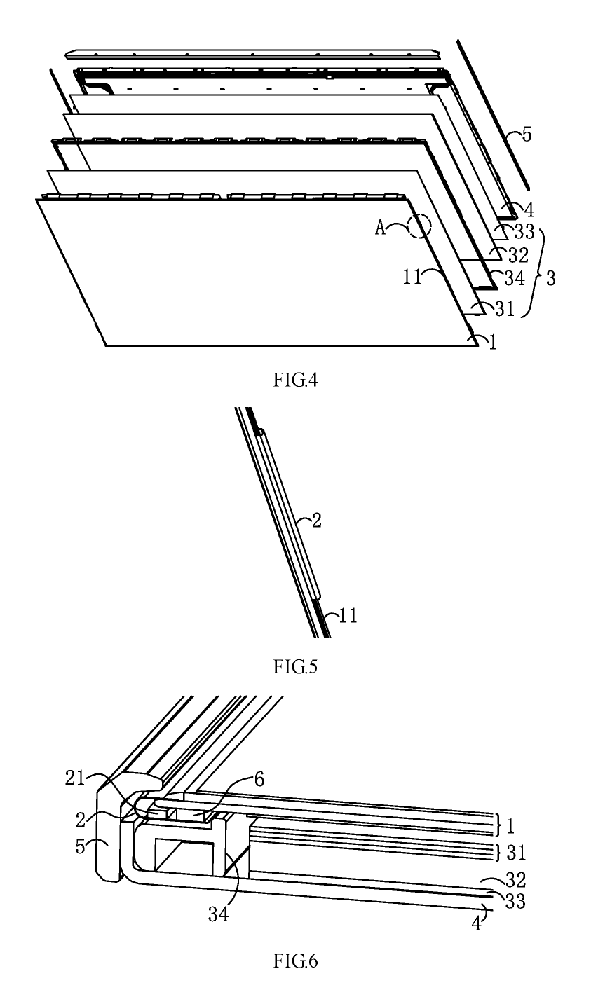

Referring to FIGS. 4, 5, and 6, the LCD includes the liquid crystal panel 1, the gate COF structure 2 at two lateral sides 11 of the liquid crystal panel 1, the backlight module 3 behind the liquid crystal panel 1, the backplate 4 behind the backlight module 3, and the front frame 5 at two lateral sides of the liquid crystal panel 1, backlight module 3, and the backplate 4. The liquid crystal panel 1, the backlight module 3, and the backplate 4 are assembled together, and two lateral sides of the assembled components are fixed by the front frame 5.

It can be understood that the LCD further includes a cover arranged above the liquid crystal panel, the backlight module, and the backplate. After the liquid crystal panel, the backlight module, and the backplate are assembled, the top of the assembled components is fixed by the cover. The cover may be a conventional cover, and thus the descriptions are omitted hereinafter.

Referring to FIGS. 4 and 6, the backlight module 3 includes a film 31, a light guiding plate 32, and a reflective sheet 33. The plastic frame 34 is arranged in a rim of the film 31, the light guiding plate 32, and the reflective sheet 33. The plastic frame 34 fixes the film 31, the light guiding plate 32, and the reflective sheet 33 within itself. FIG. 6 is a cross-sectional view of the LCD in accordance with the second embodiment. The plastic frame 34 functions as the outer frame of the backlight module, and is arranged at the left side of the film 31, the light guiding plate 32, and the reflective sheet 33. The front frame 5 is arranged at an outer side of the plastic frame 34, i.e., the left side of the plastic frame 34 as shown in FIG. 6. In addition, the front frame 5 includes a first bending portion, which extends from an top edge toward the liquid crystal panel 1. The backplate 4 is arranged in the bottoms of the plastic frame 34 and the reflective sheet 33. In addition, a left edge of the backplate 4 is bent toward the front frame 5 to form a second bending portion received in a space between the front frame 5 and the plastic frame 34. The liquid crystal panel 1, the first bending portion of the front frame 5, and the second bending portion of the backplate 4 cooperatively form a receiving space.

It can be understood that the backlight module further includes a light source (not shown) arranged at one side of the light guiding plate. The light source may be arranged between the light guiding plate and the plastic frame, or may be arranged within a receiving slot within the plastic frame, and the receiving slot includes the light source.

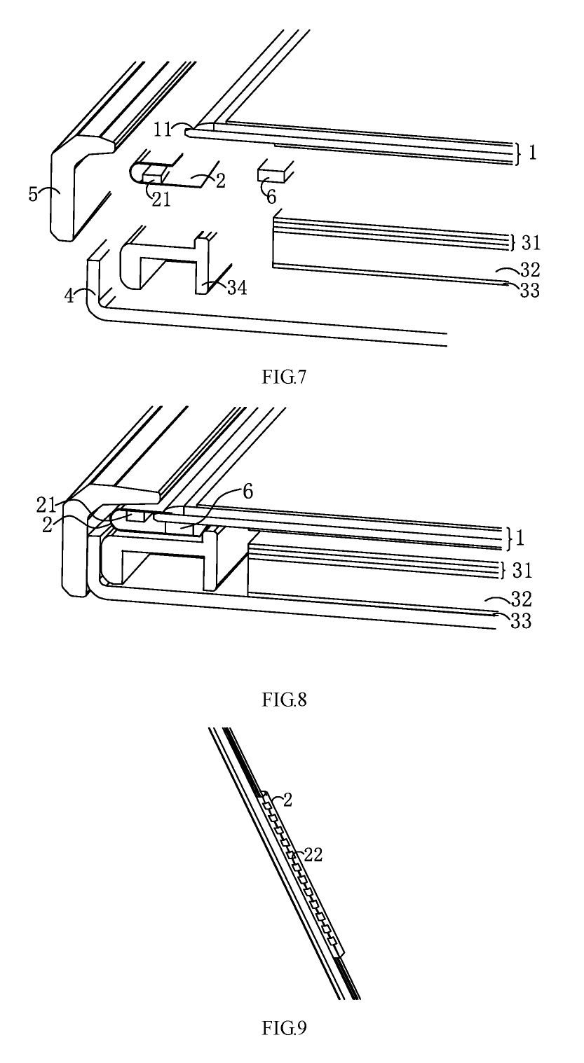

Referring to FIGS. 6 and 7, one end of the gate COF structure 2, i.e., the right end of the top surface of the gate COF structure 2 of FIG. 7, connects to the edge 11 of the liquid crystal panel 1, i.e., the left side of the liquid crystal panel of FIG. 7. The gate COF structure 2 is bent from the above end by 190 degrees toward the back surface of the liquid crystal panel 1. The other end of the gate COF structure 2, i.e., the right end of the gate COF structure 2, is adhered to the back side of the liquid crystal panel 1 by the double-sided adhesive 6 so as to fix the gate COF structure 2 at a lateral side of the liquid crystal panel 1. The plastic frame 34 of the backlight module is arranged below the gate COF structure 2. The front frame 5 is arranged at the outer side, i.e., the left side in FIG. 7, of the bending portion of the gate COF structure 2 such that the gate COF structure 2 is received within the receiving space. In the embodiment, the gate COF structure is bent by 180 degrees and is fixed around the lateral side of the liquid crystal panel such that the structure of the gate COF structure is compact, which contributes to the thin and narrow border design of the LCDs.

As shown in FIGS. 6 and 7, the gate COF structure 2 includes a chip 21 fixed thereon. The chip 21 is received in a space defined by the bending portion of the gate COF structure 2. The chip 21 is arranged below the liquid crystal panel 1, that is, the chip 21 faces toward the back side of the liquid crystal panel 1. At this moment, the thickness of the double-sided adhesive 6 for bonding the gate COF structure and the liquid crystal panel is larger than the thickness of the chip 21 such that the chip is prevented from being contacted with the back side of the liquid crystal panel. As such, the gate COF structure 2 is prevented from being damaged due to the contact between the chip and the liquid crystal panel. It can be understood that, in the embodiment, the chip may be arranged in other locations. As shown in FIG. 8, the chip 21 is arranged at a lateral side of the liquid crystal panel 1, and the thickness of the double-sided adhesive 6 is not limited to the thickness of the chip 21.

In addition, as the stress may exist in the bending portion of the gate COF structure, which may affects the circuits on the COF, as shown in FIG. 9, a plurality of through holes 22 may be arranged in the bending portion of the gate COF structure 2, which form a hollow structure, so as to release the stress. The through holes are formed by cutting type method. When designing the circuits of the gate COF structure 2, the locations of the through holes have to be configured such that the gate COF structure is prevented from being affected.

In the present disclosure, a structural component of liquid crystal panels and gate COF. The structural component relates to the gate COF structure arranged on the lateral side of the liquid crystal panel.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A structural component of liquid crystal panels and gate COFs, comprising:
a liquid crystal panel and gate COF structures arranged at two lateral sides of the liquid crystal panel, wherein:
one end of the gate COF structure connects to an edge of the liquid crystal panel, and the gate COF structure is bent from the edge of the liquid crystal panel toward a back side of the liquid crystal panel, and the other end of the gate COF structure connects to the back side of the liquid crystal panel.

2. The structural component as claimed in claim 1, wherein the gate COF structure is bent by an angle larger than 90 degrees.

3. The structural component as claimed in claim 1, wherein a chip is fixed on the gate COF structure, and the chip is received in an internal space defined by a bending portion of the gate COF structure.

4. The structural component as claimed in claim 3, wherein the chip is arranged at a lateral side of the liquid crystal panel, or the chip is arranged to be opposite to the back side of the liquid crystal panel.

5. The structural component as claimed in claim 1, wherein the gate COF structure is adhered to the back side of the liquid crystal panel by a double-sided adhesive tape.

6. The structural component as claimed in claim 2, wherein the gate COF structure is adhered to the back side of the liquid crystal panel by a double-sided adhesive tape.

7. The structural component as claimed in claim 3, wherein the gate COF structure is adhered to the back side of the liquid crystal panel by a double-sided adhesive tape.

8. The structural component as claimed in claim 4, wherein the gate COF structure is adhered to the back side of the liquid crystal panel by a double-sided adhesive tape.

9. The structural component as claimed in claim 1, wherein a bending portion of the gate COF structure includes a hollow structure.

10. The structural component as claimed in claim 2, wherein a bending portion of the gate COF structure includes a hollow structure.

11. The structural component as claimed in claim 3, wherein a bending portion of the gate COF structure includes a hollow structure.

12. The structural component as claimed in claim 4, wherein a bending portion of the gate COF structure includes a hollow structure.

13. A liquid crystal device (LCD), comprising:
a liquid crystal panel, gate COF structures arranged at two lateral sides of the liquid crystal panel, a backlight module arranged behind the liquid crystal panel, a front frame arrange at an outer side of the liquid crystal panel and the backlight module, wherein:
one end of the gate COF structure connects to an edge of the liquid crystal panel, and the gate COF structure is bent from the edge of the liquid crystal panel toward a back side of the liquid crystal panel, and the other end of the gate COF structure connects to the back side of the liquid crystal panel, the backlight module is arranged behind the gate COF structure, the front frame is arranged around an outer side of the bending portion of the gate COF structure, and the liquid crystal panel, the backlight module, and the front frame cooperatively define a receiving space for the gate COF structures.

14. The LCD as claimed in claim 13, wherein the backlight module comprises a film, a light guiding plate, and a reflective sheet arranged behind the liquid crystal panel in sequence, a plastic frame is arranged in a rim of the film, the light guiding plate, and the reflective sheet for fixing the film, the light guiding plate, and the reflective sheet, and the plastic frame, the liquid crystal panel, and the front frame cooperatively define the receiving space.

15. The LCD as claimed in claim 13, wherein the LCD further comprises a backplate arranged behind the backlight module and arranged at an inner side of the front frame.

16. The LCD as claimed in claim 13, wherein a bending portion of the gate COF structure includes a hollow structure.

17. The LCD as claimed in claim 14, wherein a bending portion of the gate COF structure includes a hollow structure.

18. The LCD as claimed in claim 15, wherein a bending portion of the gate COF structure includes a hollow structure.
